(19) United States
(12) Patent Application Publication
(10) Pub. No.: US 2018/0004339 A1
(43) Pub. Date: Jan. 4, 2018

(54) TOUCH SENSITIVE DISPLAY WITH DYNAMICALLY MODIFIABLE WRITING SURFACE

(71) Applicant: Intel Corporation, Santa Clara, CA (US)

(72) Inventors: Shantanu D. KULKARNI, Hillsboro, OR (US); Prosenjit Ghosh, Portland, OR (US); Denica L. Larsen, Hillsboro, OR (US); Jordan E. Maslov, Hillsboro, OR (US)

(21) Appl. No.: 15/201,417

(22) Filed: Jul. 2, 2016

(51) Int. Cl. G06F 3/041; G06F 3/0354; G06F 3/01; G06F 3/045; G06F 3/044

(52) U.S. Cl. CPC G06F 3/0416; G06F 3/045; G06F 3/044; G06F 3/016; G06F 3/03547; G06F 3/03545; G06F 3/0412

(57) ABSTRACT

Embodiments are generally directed to a touch sensitive screen with dynamically modifiable writing surface. An embodiment of a display includes a dynamically modifiable writing surface, the writing surface including one or more configuration mechanisms; a touch sensitive element coupled with the writing surface; and a display element coupled with the touch sensitive layer, wherein the one or more configuration mechanisms are configurable to modify one or more characteristics of the writing in response to an activation received by the display.

### TECHNICAL FIELD

Embodiments described herein generally relate to the field of electronic devices and, more particularly, a touch sensitive screen with dynamically modifiable writing surface.

### BACKGROUND

In the operation of electronic devices, including mobile devices, having a touch screen for input, many users prefer the use of a stylus for writing and drawing because of the act of writing on a surface is a familiar experience that allows for comfortable operation, and may further allow for improved accuracy and speed for certain tasks.

However, a disadvantage of stylus entry for a touch screen is that the writing surface in general does not provide the feel of a natural surface for writing or drawing, and further does not allow for variation or modification to change the writing sensation. As a result, the use of a stylus for input on such a surface does not provide the sensory feedback that a user feels when writing or drawing on a physical surface with a pen, pencil, brush, or other handheld writing instrument.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 illustrates an apparatus or system with dynamically modifiable touch sensitive display according to an embodiment;

FIG. 2 illustrates a touch sensitive display according to an embodiment;

FIG. 3 is an illustration of parameters affecting a writing experience utilizing a modifiable writing surface according to an embodiment;

FIG. 4 illustrates a touch sensitive display with dynamically modifiable writing surface according to an embodiment;

FIG. 5 is an illustration of a process for dynamic modification of writing experience for a user according to an embodiment;

FIG. 6A is an illustration of a dynamic surface texturing process for modification of a writing surface according to an embodiment;

FIG. 6B is an illustration of a dynamic stiffness/friction process for modification of a writing surface according to an embodiment; and

FIG. 7 is an illustration of an embodiment of an apparatus or system including a display with a dynamically modifiable writing surface according to an embodiment.

### DETAILED DESCRIPTION

Embodiments described herein are generally directed to a touch sensitive display with dynamically modifiable writing surface.

For the purposes of this description, the following shall apply:

“Touch sensitive display” or “touch screen” refers to an electronic visual display for an electronic device that includes both display capability and touch sensitivity. A touch sensitive display commonly allows input of data or commands by a user through contact or proximity (generally referred to as touch) with the display by a user, where the touch may include use of a user's finger or a device such as a stylus. A touch sensitive display may include, but is not limited to, a capacitive touchscreen, a resistive touchscreen, or other known touch sensitive technology.

“Writing” refers to any input with a stylus, finger, or other element to a touch sensitive display. Such input may include, but is not limited to, writing words or symbols, drawing or otherwise creating shapes, interacting with a graphical user interface (GUI), or otherwise providing input to a touch sensitive display.

“Mobile device” or “mobile electronic device” refers to a smartphone, smartwatch, tablet computer, detachable computer, notebook or laptop computer, handheld computer, mobile Internet device, or other mobile electronic device that includes processing and display capability.

In some embodiments, an apparatus or system includes a touch sensitive display with a dynamically modifiable writing surface for input by a user of the apparatus or system.

There is a need for stylus based writing technology to provide an improved writing experience, and in particular to provide surface qualities that will appeal to a wide range of users for varied tasks. The writing experience for a user is very subjective to the user and the specific task at hand, and thus any fixed solution for a writing surface will be found wanting for certain users and certain tasks. There is no conventional solution that will provide a range of different experiences for input through a touch sensitive display, or that will allow a user to pick and dynamically customize the writing surface.

For existing touch sensitive writing devices, it is common to implement a certain “paper like” feel on the writable display. However, this is only a one point solution that will address one type of writing. Disadvantages of common approach include the fact that each user has different perception of writing, and thus any fixed solution will be inadequate for certain users and certain purposes.

In some embodiments, an apparatus, system, or process provides for provides a dynamically modifiable writing surface for input by a user of the apparatus or system. In some embodiments, characteristics, properties, or other aspects of a modifiable writing surface (generally referred to herein as the characteristics of the writing surface) are dynamically alterable by the end user to suit the user's choice for a best writing experience. In this matter, very different writing experiences may be provided by a single stylus driven systems for different users and usages.

In some embodiments, an apparatus, system, or process provides for modifying a touch sensitive display by deforming, stretching, or otherwise changing the material, geometry, design, or other feature of the writing surface display using a configuration mechanism of the display to generate the changes in characteristics of the modifiable writing surface. In some embodiments, an apparatus, system, or process provides for dynamic tuning of the characteristics of the writing surface by a user, which may allow for a user to adjust the writing surface characteristics to provide a certain feel for a certain purpose. In some embodiments, the dynamic changes in the characteristics of the writing surface are may be directed by the setting of one or more writing parameters. In some embodiments, a range of writing experiences can be generated by the touchscreen display of an apparatus or system according to one or more writing parameters.

In some embodiments, an apparatus, system, or process provides for applying one or more activation means to actuate the changes in characteristics of the writing surface, wherein such activation means may include, but are not limited to, electrical, thermal, mechanical, optical, or other activation. As used here, an actuator refers to one or more elements to apply or affect such electrical, thermal, mechanical, optical, or other means.

In some embodiments, an apparatus, system, or process may utilize study and analysis of real world surfaces to recreate characteristics of known writing surfaces for implementation in the dynamic modification of a writing surface.

In some embodiments, the characteristics of the writing surface that are dynamically modifiable include, but are not limited to, mechanical characteristics of the writing surface, such as tactile or finish qualities and a coefficient of friction of the surface material, and optical characteristics of the writing surface, such as transmittance, haze, or gloss of the writing surface.

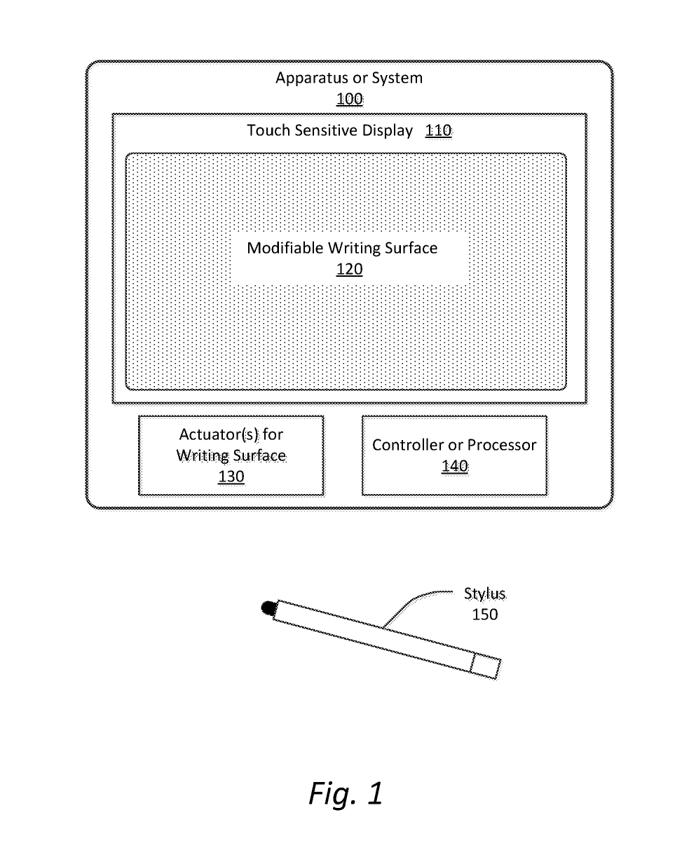

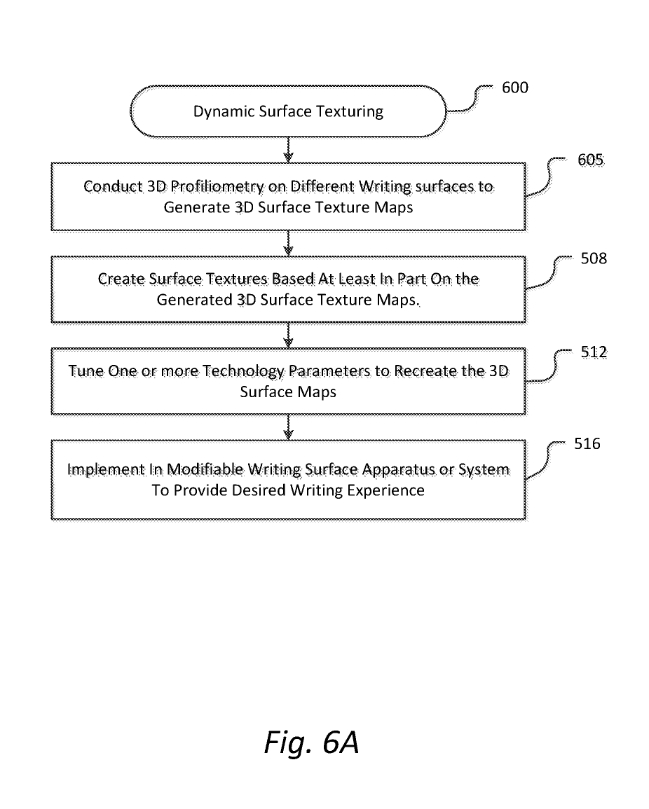

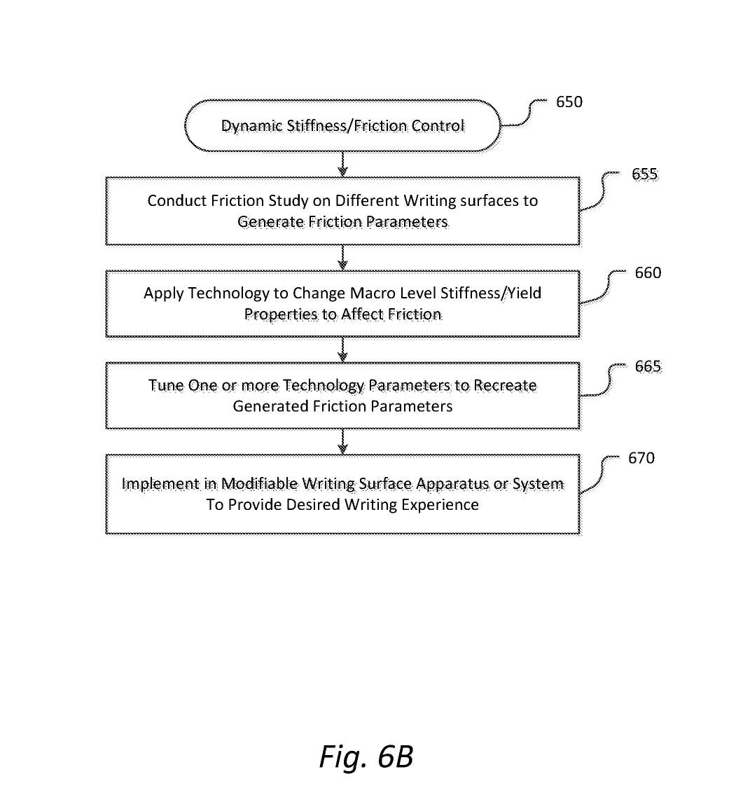

FIG. 1 illustrates an apparatus or system with a dynamically modifiable touch sensitive display according to an embodiment. Further elements of an apparatus or system may be as illustrated in FIG. 6.

In some embodiments, an apparatus or system 100 includes a touch sensitive display 110, the touch sensitive display 110 including a dynamically modifiable writing surface 120 having one or more dynamically modifiable characteristics, the modifiable characteristics including, but not limited to, mechanical characteristics and optical characteristics of the writing surface.

In some embodiments, the apparatus or system includes, but is not limited to, one or more actuators 130 for the modifiable writing surface 120. In some embodiments, the one or more actuators are to apply electrical, thermal, mechanical, or other activation to the one or more configuration mechanisms of the writing surface 120 to modify the characteristics of the writing surface. In some embodiments, the apparatus or system includes a controller or processor 140 to provide control, including receiving or obtaining configuration data for the writing surface 120, and providing signals or commands to the one or more actuators 130 to implement desired changes to the modifiable writing surface 120.

In some embodiments, writing on the modifiable writing surface 120 includes utilization of a stylus 150 on the writing surface. In some embodiments, the modifiable characteristics of the writing surface are directed towards providing one or more writing experience in the use of the stylus. For example, first setting may provide for characteristics that correspond to writing with a pencil on a pad of paper, a second setting may provide for characteristics that correspond to drawing with a brush on a canvas surface; and a third setting may provide for characteristics that correspond to writing with a fountain pen on thick stationary.

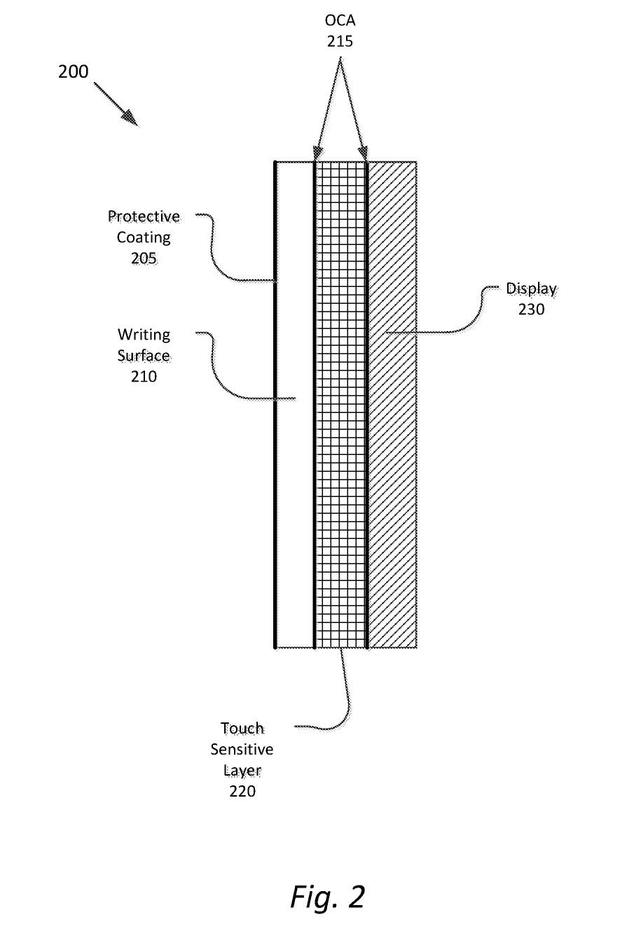

FIG. 2 illustrates a touch sensitive display according to an embodiment. In most implementations, a touch enabled display 200 includes multiple different layers or elements, an example of which is as shown in FIG. 2. However, implementations are not limited to the layers illustrated in FIG. 2, and may include additional or different layers or elements in the display stack. The thicknesses of each layer or coating are not intended to be drawn to scale.

In the illustrated example, a writing surface layer 210 is commonly made of etched glass, plastic, or polymer material, the backside (inner surface) of which is attached to a touch sensor layer 220. The touch sensor layer 220 may include, for example, a metal mesh, ITO, OGS (One Glass Solution) layer, or other touch sensitive components. A display layer 230 is attached to the touch sensitive layer 220, wherein the touch sensor layer 220 is coupled with a display layer 430. In some embodiments, the layers are bonded together with an optically clear adhesive (OCA) 215. In some implementations, a protective coating 205 may coat the front side (outer surface) of the writing surface layer 210.

For OGS (One Glass Solution) or other similar solutions intended to provide a reduced thickness of the display, sensor traces may be embedded in the cover glass itself, while for a metal mesh type of sensor, there is a separate sensor layer attached on the backside of the writing material using optically clear adhesive. The combination of writing and sensor layers is bonded to the display. In case of an EMR (Electromagnetic Resonance) sensor unit, the sensor unit is attached to the backside of display itself.

However, the conventional implementation of a display stack is not modifiable to provide differing writing experiences for user. In some embodiments, the writing surface layer 210 is a dynamically configurable layer that allows modification in one or more properties or characteristics to enhance and vary the options available to user in writing on the touch surface.

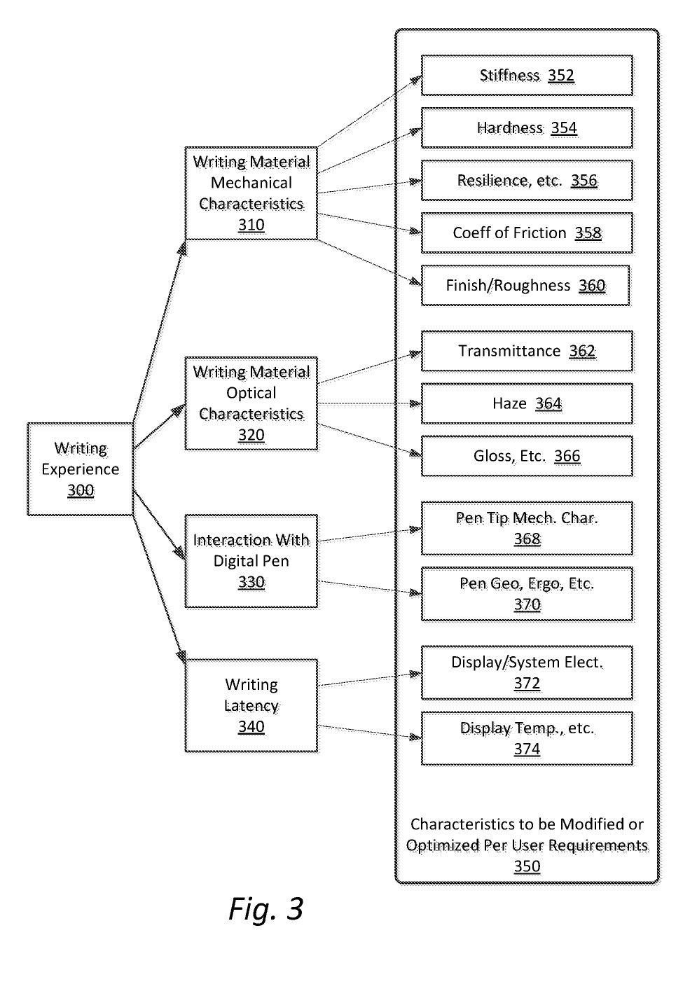

FIG. 3 is an illustration of parameters affecting a writing experience utilizing a dynamically modifiable writing surface according to an embodiment. The writing experience 300 for a user with digital devices can be a complex phenomenon because of the mixture of user expectation based on traditional writing and the characteristics of a digital input device. FIG. 3 depicts at a high level different parameters that impact an individual's writing experience using a digital device.

In the illustration provided in FIG. 3, the virtual writing experience 300 depends on writing material mechanical characteristics (in general, how the surface feels to the user) 310, the writing material optical characteristics 320 (how the surface looks to the user), the interaction of the user with the digital pen (how the stylus works with the user) 330, and the writing latency (how quickly the writing appears on the screen, where any noticeable latency to a human user may have a serious negative impact on the writing experience) 340.

In some embodiments, within each such category of characteristics are individual characteristics that may be considered for modification or optimization per user requirements 350. In some embodiments, the individual characteristics may include, but are not limited to:

Mechanical characteristics 310: Stiffness 352, hardness 354, resilience and related characteristics 356, coefficient of friction 358, and finish or roughness of a surface 360.

Optical characteristics 320: Transmittance (degree to which light is transmitted through the surface) 362, haze 364, and gloss or other related optical elements of the surface 366.

Interaction of user and digital pen 330: Pen tip mechanical characteristics 368, and pen geometry and ergonomics 370.

Writing latency 340: Display or system electronics 372, and display temperature or other issues that may affect writing latency.

The characteristics of the writing surface are critical to the user experience, and thus may require tuning for human “writing feel” perception. Further, the expectations of a user regarding the ideal writing surface may vary widely. Certain users may prefer to write with the feel of an ink pen (such as fountain pen or cartridge pen), and others with the feel of a pencil or a ball point pen. Based on the virtual writing instrument a user prefers for a particular use, the surface requirements may be very different from user to user. For example, with the virtual ink pen, an end user may require a rougher surface with higher stiffness while with the virtual ball point pen the user may prefer to use a surface with more yield.

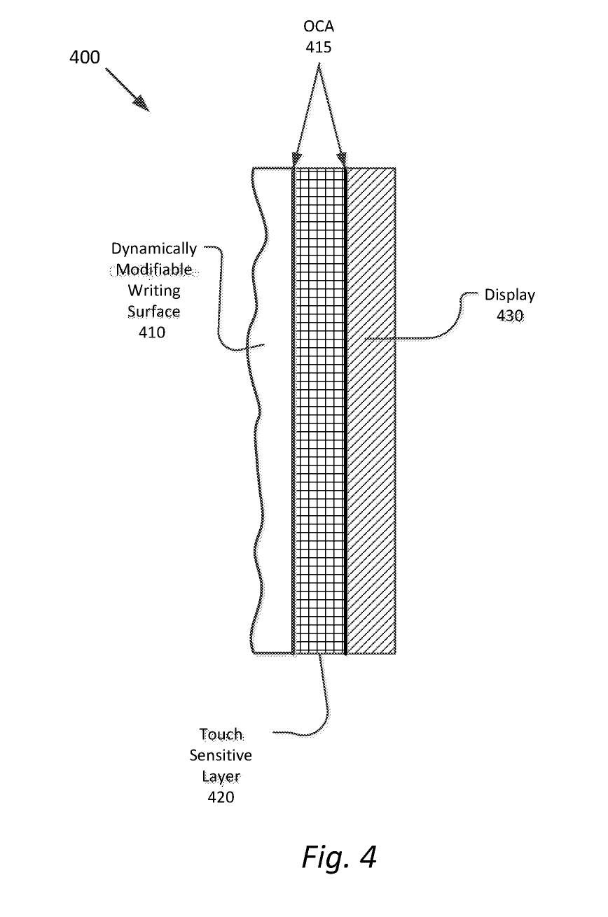

FIG. 4 illustrates a touch sensitive display with dynamically modifiable surface according to an embodiment. In most implementations, a touch sensitive display 400 includes multiple different layers, including a writing surface layer 410 coupled with a touch sensor layer 420, which is coupled with a display layer 420, where the layers may bonded together with an optically clear adhesive (OCA) 415. In some embodiments, the writing surface 410 is a dynamically modifiable writing surface. In some embodiments, upon actuation of the writing surface, the writing material characteristics are dynamically altered to create different writing feel and range of writing.

In some embodiments, different configuration mechanisms may be implemented in the touch sensitive display 400 to provide changes in characteristics of the writing surface 410 for writing. In some embodiments, configuration mechanisms of a writing surface may include, but are not limited to:

(1) Deformable materials with microfluidics: Microfluidic deformable elastomeric materials may be applied in computing displays for tactile purposes, wherein such material deforms due to fluid pressure. In some embodiments, the fluid pressure can be controlled and is applied by the fluid that runs through grooves inside the material layers. In some embodiments, certain grooves and cavities below the writing material layer and micro pumping of transparent fluid may be implemented to create different writing feel in terms of stiffness, texture, and other characteristics.

(2) Electroactive polymer (EAP or artificial material): EAP material changes shape or size after electrical activation. There are different actuation mechanisms applicable for EAP material, such as ionic, piezoelectric, and dielectric. In some embodiments, changes of shape may be engineered in the EAP material to produce different types of writing feel.

(3) Memory alloy: Memory alloy in general exhibits reversible shape change with temperature. More specifically, shape-memory alloy or memory wire (including nickel titanium, or nitinol, alloy) is an alloy that returns to an original shape after deformation upon heating or application of current. In some embodiments, a specially designed array of memory wires attached to a flexible writing surface may provide a change in shape with current or heat.

(4) Smart glass: Smart glass is a material or glazing that changes optical properties of the writing surface when an activation means, such as voltage, light, or heat, is applied. In some embodiments, a modifiable writing surface may include smart glass to change optical characteristics per user requirements upon application of the activation means.

In some embodiments, the display 400 includes one or more mechanisms to provide modifications to the writing surface 410, wherein the mechanisms may include, but are not limited to, deformable materials with microfluidics, electroactive polymer, metal alloy, and smart glass.

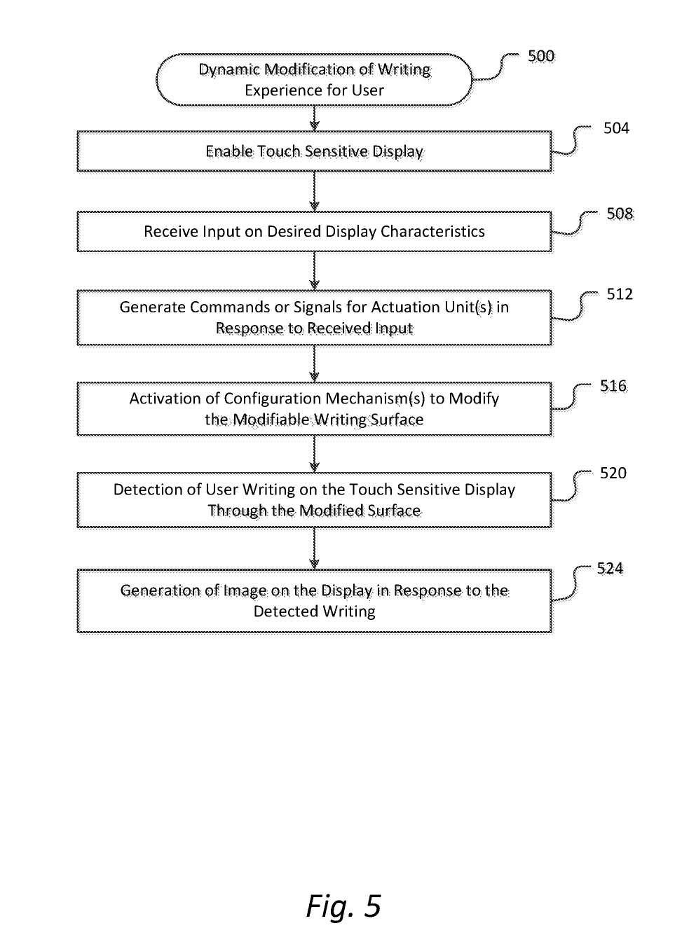

FIG. 5 is an illustration of a process for dynamic modification of writing experience for a user according to an embodiment. In some embodiments, a process may include enabling a touch sensitive display for operation by a user 504. In some embodiments, input on desired characteristics for a modifiable surface is received 508, such as receipt of display configuration data from a user. In some embodiments, the touch sensitive display includes a dynamically modifiable writing surface for providing for dynamic modification of one or more characteristics of the writing surface.

In some embodiments, commands or signals for one or more actuation units are generated in response to the input on writing surface characteristics 512. In some embodiments, the one or more actuation units provide activation for one or more configuration mechanisms to modify the writing surface of the configuration writing surface 515, wherein the activation may include fluid pressure, electrical activation, thermal activation, or optical activation for the modifiable writing surface.

In some embodiments, the process then proceeds with detecting user writing on the modifiable writing surface through the modified surface 520, and the generation of an image on the display in response to the detected writing 524, such as the generation of a line representing a line drawn by the user.

In some embodiments, an apparatus, system, or process may utilize study and analysis of real world surfaces to recreate characteristics of known writing surfaces for implementation in the dynamic modification of a writing surface. In some embodiments, analysis of specific factors such as texture and friction of surface are applied in dynamic surface modification in order to emulate the feel of conventional surfaces, including, but not limited to, conventional papers and other natural writing materials, and tune user experience for natural writing experience. The analysis and application of surface data may include, but is not limited to, the processes illustrated in FIGS. 6A and 6B.

FIG. 6A is an illustration of a dynamic surface texturing process for modification of a writing surface according to an embodiment. In some embodiments, a process for dynamic surface texturing 600 includes:

605: Conduct three-dimensional profilometry on different paper or other writing surfaces to generate 3D surface texture maps.

610: Create surface textures through haptics or other technology based at least in part on the generated 3D surface texture maps.

615: Tune one or more technology parameters to recreate the 3D surface maps generated in process 605.

620: Implement the tuned technology parameters in a modifiable writing surface apparatus or system to provide desired writing experience.

FIG. 6B is an illustration of a dynamic stiffness/friction process for modification of a writing surface according to an embodiment. In some embodiments, a process for dynamic stiffness/friction control 650 includes the following:

655: Conduct friction study on various papers and other writing surfaces to generated parameters for different pen and paper combinations (or, more generally, writing instrument-writing surface combinations).

660: Application of technology (including, but not limited to microfluidics or electroactive polymer) to change macro level stiffness/yield properties to modify friction.

665: Tune one or more technology activation parameters to recreate different friction parameters generated in process 655.

670: Implement the tuned technology parameters in a modifiable writing surface apparatus or system to provide the desired writing experience.

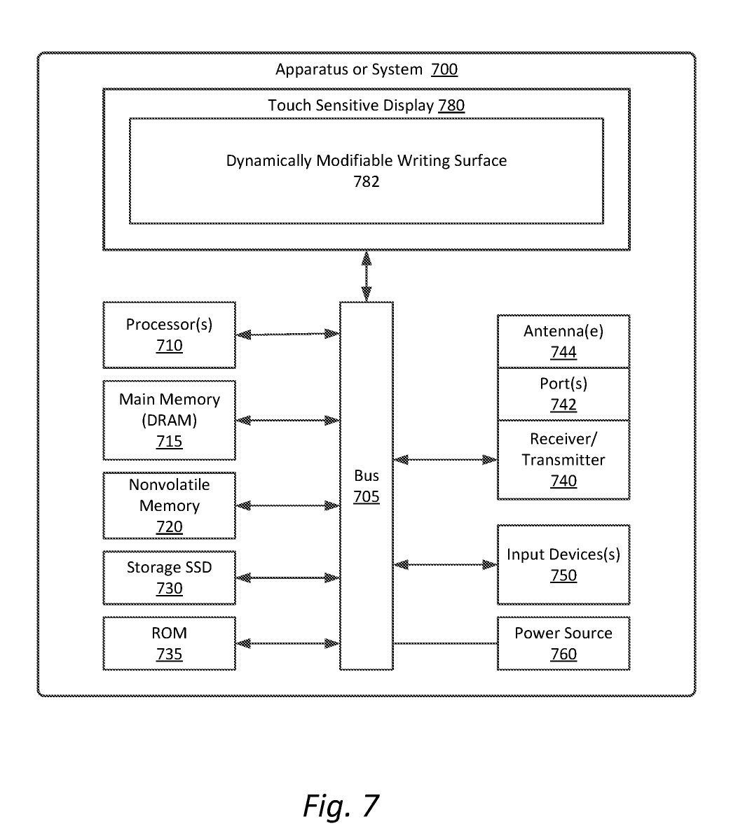

FIG. 7 is an illustration of an embodiment of an apparatus or system including a dynamically modifiable display according to an embodiment. In this illustration, certain standard and well-known components that are not germane to the present description are not shown. Elements shown as separate elements may be combined, including, for example, an SoC (System on Chip) combining multiple elements on a single chip.

In some embodiments, an apparatus or system 700, such as a mobile device, includes a touch sensitive display 780. In some embodiments, the touch sensitive display 780 includes a dynamically modifiable display surface 782, such as the dynamically modifiable writing surface 410 illustrated in FIG. 4. In some embodiments, the display surface 782 is operable to change one or more characteristics in response to an activation means applied to the surface to provide a modifiable writing surface for a user. In some embodiments, the touch sensitive display 780 includes one or more configuration mechanisms to deform or otherwise modify the writing surface.

In some embodiments, the apparatus or system 700 may include a processing means such as one or more processors 710 coupled to one or more buses or interconnects, shown in general as bus 705. The processors 710 may comprise one or more physical processors and one or more logical processors. In some embodiments, the processors may include one or more general-purpose processors or special-processor processors.

The bus 705 is a communication means for transmission of data. The bus 705 is illustrated as a single bus for simplicity, but may represent multiple different interconnects or buses and the component connections to such interconnects or buses may vary. The bus 705 shown in FIG. 7 is an abstraction that represents any one or more separate physical buses, point-to-point connections, or both connected by appropriate bridges, adapters, or controllers.

In some embodiments, the apparatus or system 700 further comprises a random access memory (RAM) or other dynamic storage device or element as a main memory 715 for storing information and instructions to be executed by the processors 710. Main memory 715 may include, but is not limited to, dynamic random access memory (DRAM).

The apparatus or system 700 also may comprise a non-volatile memory 720; a storage device such as a solid state drive (SSD) 730; and a read only memory (ROM) 735 or other static storage device for storing static information and instructions for the processors 710.

In some embodiments, the apparatus or system 700 includes one or more transmitters or receivers 740 coupled to the bus 705. In some embodiments, the apparatus or system 700 may include one or more antennae 744, such as dipole or monopole antennae, for the transmission and reception of data via wireless communication using a wireless transmitter, receiver, or both, and one or more ports 742 for the transmission and reception of data via wired communications. Wireless communication includes, but is not limited to, Wi-Fi, Bluetooth™, near field communication, and other wireless communication standards.

In some embodiments, the apparatus or system 700 includes one or more input devices 750 for the input of data, including hard and soft buttons, a joy stick, a mouse or other pointing device, a keyboard, voice command system, or gesture recognition system. In some embodiments, the touch sensitive display is utilized as at least a part of an input device 750.

The apparatus or system 700 may also comprise a battery or other power source 760, which may include a solar cell, a fuel cell, a charged capacitor, near field inductive coupling, or other system or device for providing or generating power in the apparatus or system. The power provided by the power source 760 may be distributed as required to elements of the apparatus or system 600.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of“an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, a device includes a dynamically modifiable writing surface, the writing surface including one or more configuration mechanisms, a touch sensitive element coupled with the writing surface; and a display element coupled with the touch sensitive element, wherein the one or more configuration mechanisms are configurable to modify one or more characteristics of the writing in response to an activation received by the display.

In some embodiments, the one or more characteristics include one or more of mechanical characteristics of the writing surface; and optical characteristics of the writing surface.

In some embodiments, the mechanical characteristics of the writing surface include one or more of stiffness, hardness, resilience, friction, and finish of the writing surface.

In some embodiments, the optical characteristics of the writing surface include one or more of transmittance, haze, and gloss of the writing surface.

In some embodiments, the display one or more actuators to provide the activation for the configuration of the writing surface; and one or more controllers to control the one or more actuators.

In some embodiments, the one or more actuators provide one or more of electrical, thermal, mechanical, or optical activation.

In some embodiments, the one or more activation mechanisms include one or more of deformable materials activated with microfluidics; electroactive polymer (EAP) material; memory alloy; and smart glass.

In some embodiments, the writing surface, a touch sensitive element, and display element are layers in a display stack.

In some embodiments, a non-transitory computer-readable storage medium having stored thereon data representing sequences of instructions that, when executed by a processor, cause the processor to perform operations including receiving an input for one or more characteristics of a dynamically modifiable writing surface of a display, the display further including a touch sensitive element; generating one or more commands or signals in response to the input; providing an activation to a configuration mechanism of the display in response to the one or more commands or signals, wherein the configuration mechanism is to change the one or more characteristics of the writing surface; and receiving touch input on the display via the writing surface.

In some embodiments, the one or more characteristics include one or more of more of mechanical characteristics of the writing surface; and optical characteristics of the writing surface.

In some embodiments, the mechanical characteristics of the writing surface include one or more of stiffness, hardness, resilience, friction, and finish of the writing surface.

In some embodiments, the optical characteristics of the writing surface include one or more of transmittance, haze, and gloss of the writing surface.

In some embodiments, providing the activation includes providing one or more of electrical, thermal, mechanical, or optical activation.

In some embodiments, the one or more characteristics are based at least in part on study and analysis of real world surfaces to recreate characteristics of known writing surfaces.

In some embodiments, an apparatus includes means for receiving an input for one or more characteristics of a dynamically modifiable writing surface of a display, the display further including a touch sensitive element; means for generating one or more commands or signals in response to the input; means for providing an activation to a configuration mechanism of the display in response to the one or more commands or signals, wherein the configuration mechanism is to change the one or more characteristics of the writing surface; and means for receiving touch input on the display via the writing surface.

In some embodiments, the one or more characteristics include one or more of more of mechanical characteristics of the writing surface; and optical characteristics of the writing surface.

In some embodiments, the mechanical characteristics of the writing surface include one or more of stiffness, hardness, resilience, friction, and finish of the writing surface.

In some embodiments, the optical characteristics of the writing surface include one or more of transmittance, haze, and gloss of the writing surface.

In some embodiments, providing the activation includes providing one or more of electrical, thermal, mechanical, or optical activation.

In some embodiments, the one or more characteristics are based at least in part on study and analysis of real world surfaces to recreate characteristics of known writing surfaces.

In some embodiments, a system includes one or more processors to process data; a touch sensitive display to receive input by touch detection and to display images, wherein the touch sensitive display includes a dynamically modifiable writing surface, the writing surface including one or more configuration mechanisms, a touch sensitive element coupled with the writing surface, and a display element coupled with the touch sensitive element, and a receiver or transmitter and antenna to wirelessly transmit or receive data.

In some embodiments, the one or more characteristics include one or more of more of mechanical characteristics of the writing surface; and optical characteristics of the writing surface.

In some embodiments, the mechanical characteristics of the writing surface include one or more of stiffness, hardness, resilience, friction, and finish of the writing surface.

In some embodiments, the optical characteristics of the writing surface include one or more of transmittance, haze, and gloss of the writing surface.

In some embodiments, the system further includes one or more actuators to provide the activation for the configuration of the writing surface; and one or more controllers to control the one or more actuators.

In some embodiments, the one or more actuators provide one or more of electrical, thermal, mechanical, or optical activation.

In some embodiments, the one or more activation mechanisms include one or more of deformable materials activated with microfluidics; electroactive polymer (EAP) material; memory alloy; and smart glass.

In some embodiments, the system includes a mobile electronics device.

What is claimed is:

1. A display comprising:
a dynamically modifiable writing surface, the writing surface including one or more configuration mechanisms;
a touch sensitive element coupled with the writing surface; and
a display element coupled with the touch sensitive element;
wherein the one or more configuration mechanisms are configurable to modify one or more characteristics of the writing in response to an activation received by the display.

2. The display of claim 1, wherein the one or more characteristics include one or more of:
mechanical characteristics of the writing surface; and
optical characteristics of the writing surface.

3. The display of claim 2, wherein the mechanical characteristics of the writing surface include one or more of stiffness, hardness, resilience, friction, and finish of the writing surface.

4. The display of claim 2, wherein the optical characteristics of the writing surface include one or more of transmittance, haze, and gloss of the writing surface.

5. The display of claim 1, further comprising:
one or more actuators to provide the activation for the configuration of the writing surface; and
one or more controllers to control the one or more actuators.

6. The display of claim 5, wherein the one or more actuators provide one or more of electrical, thermal, mechanical, or optical activation.

7. The display of claim 6, wherein the one or more activation mechanisms include one or more of:
deformable materials activated with microfluidics;
electroactive polymer (EAP) material;
memory alloy; and
smart glass.

8. The display of claim 1, wherein the writing surface, a touch sensitive element, and display element are layers in a display stack.

9. A non-transitory computer-readable storage medium having stored thereon data
representing sequences of instructions that, when executed by a processor, cause
the processor to perform operations comprising:
receiving an input for one or more characteristics of a dynamically modifiable writing surface of a display, the display further including a touch sensitive element;
generating one or more commands or signals in response to the input;
providing an activation to a configuration mechanism of the display in response to the one or more commands or signals, wherein the configuration mechanism is to change the one or more characteristics of the writing surface; and
receiving touch input on the display via the writing surface.

10. The medium of claim 9, wherein the one or more characteristics include one or more of more of:
mechanical characteristics of the writing surface; and
optical characteristics of the writing surface.

11. The medium of claim 10, wherein the mechanical characteristics of the writing surface include one or more of stiffness, hardness, resilience, friction, and finish of the writing surface.

12. The medium of claim 10, wherein the optical characteristics of the writing surface include one or more of transmittance, haze, and gloss of the writing surface.

13. The medium of claim 9, wherein providing the activation includes providing one or more of electrical, thermal, mechanical, or optical activation.

14. The medium of claim 9, wherein the one or more characteristics are based at least in part on study and analysis of real world surfaces to recreate characteristics of known writing surfaces.

15. A system comprising:
one or more processors to process data;
a touch sensitive display to receive input by touch detection and to display images, wherein the touch sensitive display includes:
a dynamically modifiable writing surface, the writing surface including one or more configuration mechanisms,
a touch sensitive element coupled with the writing surface, and
a display element coupled with the touch sensitive element; and
a receiver or transmitter and antenna to wirelessly transmit or receive data.

16. The system of claim 15, wherein the one or more characteristics include one or more of more of:
mechanical characteristics of the writing surface; and
optical characteristics of the writing surface.

17. The system of claim 16, wherein the mechanical characteristics of the writing surface include one or more of stiffness, hardness, resilience, friction, and finish of the writing surface.

18. The system of claim 16, wherein the optical characteristics of the writing surface include one or more of transmittance, haze, and gloss of the writing surface.

19. The system of claim 15, further comprising:
one or more actuators to provide the activation for the configuration of the writing surface; and
one or more controllers to control the one or more actuators.

20. The system of claim 19, wherein the one or more actuators provide one or more of electrical, thermal, mechanical, or optical activation.

21. The system of claim 20, wherein the one or more activation mechanisms include one or more of:
deformable materials activated with microfluidics;
electroactive polymer (EAP) material;
memory alloy; and
smart glass.

22. The system of claim 15, wherein the system includes a mobile electronics device.
